(19) United States
(12) Patent Application Publication
(10) Pub. No.: US 2022/0163377 A1
(43) Pub. Date: May 26, 2022

(54) SYSTEM AND METHOD FOR DETECTING VIBRATIONS IN THE PERIPHERY OF AN OPTICAL FIBRE

(71) Applicant: HUTEK INC SAS, Popayan (CO)

(72) Inventors: Cesar Alberto Sarria Villa, Popayan (CO); Juan Fernando Prado Buitrago, Popayan (CO)

(21) Appl. No.: 17/437,270

(22) PCT Filed: Mar. 11, 2020
(86) PCT No.: PCT/IB2020/052162

§ 371 Date: Sep. 8, 2021

(30) Foreign Application Priority Data
Mar. 12, 2019 (CO) NC2019/0002303

(51) Int. Cl. G01H 9/00; G01D 5/353

(52) U.S. Cl. CPC G01H 9/006; G01D 5/35303

(57) ABSTRACT

The invention relates to a system and method for detecting vibrations on the periphery of an optical fibre, which is divided into five subsystems that are connected together. First, a light-source subsystem (6) generates light, which is transmitted through an optical fibre subsystem (2). Then, speckle interference patterns generated in the optical fibre are read using a CMOS micro camera subsystem (5). Subsequently, the information is analysed by a processing subsystem (7), producing an alarm signal that is notified to the outside by means of a communications subsystem (1).

### TECHNICAL SECTOR

The current invention takes place in the security alarms field; more precisely, in the development of methods and devices of physical, industrial, and civil security that work with optical fiber. Particularly, the disclosure refers to a method and device for detecting vibrations in the periphery of an optical fiber which includes a CMOS camera and a LED laser.

### PREVIOUS TECHNIQUE

The optical fiber is a thin thread strand made of glass or fused/molten silicon that conducts light. The thickness of the filament is comparable to a single human hair, namely, 0.1 mm approximately. Three components are mandatory to establish communication with optical fiber: The light source which can be LED type or laser type, the transmitting medium which corresponds to the optical fiber, and the light detector that can be a photo-diode. The light transmission happens because the inner light beam inside the fiber, suffers an almost total reflection every time it tends to go out of the core.

The optical fibers are used in telecommunications since 1960 because they allow sending a big amount of data, covering large distances at the speed of light; therefore, its use in data transmission has become regular in the recent years. Nevertheless, the use of optical fiber as anti-intrusion sensor in perimeter security is less frequent. The implementation of the optical fiber as intrinsic sensor allows taking full advantage of the material features. Some of the advantages of using optical fiber in perimeter security comprehend immunity to electromagnetic disturbances, the great mechanical resistance which facilitates its installation, the weight is much lower than the weight of other metal cables, the non-production of interference, the heat, cold and rust resistance, the insensibility to parasites, the non-conductivity and the rust immunity.

The optical fiber works because occasionally, a light emitted by a laser is transmitted by optical fiber, and the light that emanates at the end of the fiber produces a patter known as speckled pattern. When a disturbance is presented on the fiber, even if it is small and related to changes in the environmental conditions, the speckled pattern changes and it is detected by the light receptor.

The CMOS sensors are built with Complementary Metal-Oxide-Semiconductor technology, they detect the light based on the photoelectric effect/principle and their sensibility in the spectrum range goes from 300 nm to 1000 nm approximately. When working with the CMOS sensors, the charge is transformed into an analogical voltage in every pixel within the same sensor, thus, each cell is independent. Subsequently, for every active line, the signal is amplified through the read circuit, the noise is minimized, then it is digitized and finally, it is transmitted in parallel.

The activated pixel sensors have advantages over other light detection sensors. Given that the conversion is done in each cell, when the CMOS sensors are used, an external chip for this function is not necessary, and this fact results in a reduction of the cost and size of the sensor. One of the huge advantages is that CMOS sensors are more sensitive to light, therefore, their behavior is better even when exposed to poor lightning conditions. In addition, the CMOS sensors offer higher speed because all the process is carried out inside each cell. Finally, another important advantage is related with the power consumption: they use less energy, mainly due to the signal amplifiers, which are located in the cell itself

The publication of the Korean patent KR20040105331 announce a method of speckled signal processing of an optical fiber sensor that allows monitoring intruders. The said method increases the accuracy of the monitoring system by allowing the system to filter a false signal coming from a natural phenomenon. The operation starts when the signal is photoelectrically converted into a receptor element, and then it is processed in multiple stages. Subsequently, a microprocessor compares the primary signal emitted from a comparator with reference pulse width data, unit time data, and a reference pulse number to generate an intrusion detection signal.

The publication of the patent MD2010S000037 release an intrusion alarm system with optical fiber that includes a coherent light source, alongside a multi-modal optical fiber segment, a photo-detector, and a warning alarm builder. The photo-detector corresponds to a CCD (Charge Coupled Device) to register the speckled patterns in the far field where the fiber is located. For processing, a computer is used, which contains a numerical matrix differentiator of two consecutive speckle patterns, an adder of the corresponding difference signals from every two consecutive speckle patterns, and a comparator, all connected in parallel to an alarm trigger threshold setting unit. In the system, the comparator sends the alarm signal when the addition of the difference signals of two consecutive speckle patterns exceeds the default warning alarm trigger threshold.

The U.S. Pat. No. 7,189,958 B2 announce a system, device and method to detect disturbances using an optical fiber sensor. The system comprehends a multi-modal optical fiber spatially distributed, a photo-detector configured to detect the signals coming from the said fiber, a wireless digital module coupled to the photo-detector that transmits a plurality of coded variables of the optical signals detected, a wireless receptor module, and a processing module coupled to the said receptor that decodes and interprets the signals.

According to the information above, it is clear from the technique status, that systems for vibrations detection in an optical fiber used for perimeter security already exist. Said systems use complex processing algorithms that allow triggering an alarm signal, and even several of them require the use of a computer to process calculations and further signal emission to the other systems. This requirement, besides from increasing the device size, it also increases the manufacturing and maintenance costs, and its use is limited to safe places where there is no risk of theft.

In addition, the use in the technique state of complex algorithms for processing, slow down the alarm generation process because it requires more time to finish the analysis of detected disturbances. Besides, the complex algorithms increase the energy consumption of the devices, making the maintenance more expensive for the user.

Additionally, the state-of-the-art devices use multiple conditioning stages to stabilize the reference signal and guarantee the system correct operation. The majority of the state-of-the-art systems require post-processing stages or conditioning of the analogical signal of the sensing element independently, whether it is done through operational amplifiers (op. Amp) or through other elements that are susceptible to the environmental electromagnetic noise, as it occurs with the patent U.S. Pat. No. 4,297,684.

Currently, other devices with similar features have the protection of big perimeters as their main focus. This is related to the techniques used, which are focused mainly to detect light losses by retro-dispersion or scattering. Those applied techniques require equipment that include stages or modules of optical and electronic conditioning of high accuracy, composed by electronic systems operating at a processing high-speed such as FPGAs, equipment with features similar to the ones of the OTDR systems (Optical Time Domain Relations), which are recognized for their high cost. While many of the existent systems that are available in the market have the capacity of detecting short perimeters, it is not possible to apply this type of techniques in short distance perimeters due to the investment that it requires.

Finally, the majority of the state-of-the-art systems require configuration of several parameters by the user for the operation to be possible, which makes the setup task complex for the security integrators and for the users too; the previous statement leads in many cases, to errors on the device configuration and possible failures when detecting alarms.

Accordingly, there is a need in the art, for new device models and methods for detecting vibrations in the periphery of an optical fiber; said devices and methods must be distinguished for i) working with both lightweight and low cost electronic cards so that a computer or a tablet is not a requirement for signal processing, ii) working with both recursive and low-processing algorithms to increase the device speed and reduce the energy consumption, iii) allowing the detection of disturbances in small perimeters, and iv) facilitate the device configuration through determining a few parameters to make easy its start of operation.

### DISCLOSURE OF THE INVENTION

Hence; the presented invention release a method and a device for detecting vibrations in the periphery of an optical fiber, this devices is distinguished for using a low-complexity detection method which use recursive algorithms implemented within an electronic card which makes the device lightweight, low-cost, fast, with low index of false alarms, and with low energy consumption.

Additionally, the device and the method have the advantage of allowing the disturbances detection in small perimeters, making it suitable where the technologies of periphery detection with optical fiber cannot be used normally. The processing method allow decreasing stages of analogical conditioning by simplifying the development of this type of system. Another advantage of the device is its easy configuration because only a few parameters are require for its operation which is an advantage for the users and the security integrators.

The device operation mentioned here is based on the interferometer pattern of speckle type. The interferometry use cinematic techniques to describe light patterns caused by disturbance on the optical fiber, where said patterns are analyzed through a CMOS sensor and micro-controlled embedded systems.

Therefore, the device in this invention, which allows detecting vibrations in the periphery of an optical fiber, is divided mainly in five subsystems that are interconnected between to reach the complete device operation.

In general terms, the disturbances are detected through the optical fiber system (2). To detect there must be light transmitted through the optical fiber, said light is generated by the light source system (6); thus, it is possible to read the interference speckled patterns generated in the optical fiber, when it is disturbed by means of the CMOS micro camera system (5). Afterwards, the information sent digitally through the CMOS camera is analyzed through a processing system (7) giving an alarm signal as a result, which is notified abroad through a communications system (1). Next, each one of the devices of perimeter security is explained in detail.

First, the optical fiber system (2) is composed by a sensor cable made of optical fiber (21) which length oscillates between the 1 m-5 Km interval, and two SMA-M connectors (22) coupled to each end side of the optical fiber cable to be further connected to the mechanical housing (11).

The sensor cable of the optical fiber is designed to be mounted on chain link mesh, fence, wall or even buried, attempting to detect invaders in restricted perimeters of big or medium length, corresponding to 1 m and onwards. When the optical fiber sensor is installed over a chain link mesh surface, the sensor cable must be hold and fasten with plastic ties. Before the installation of the optical fiber, it is verified that the mesh, wall or surface where the sensor is going to be installed, is well taut and free of obstacles or trees that could generate false alarms.

In a preferred embodiment of the invention, the optical fiber sensor cable/wire used is duplex type, that is to say, it is composed by two filaments together. When duplex wire is used, it is necessary to use a mechanical joint (23) to join the ends of the optical fiber cable.

In another invention embodiment, the optical fiber sensor cable used is simplex type, that is to say, it is composed by a unique filament. If simplex optical fiber is used, it is not necessary to use the mechanical junction, because it turns over itself connecting one end side to (4) and the other one to (5). Also, a laser can be connected at the end side of the fiber, taking the most of the maximum length of the fiber. The type of fiber to be used, whether it is simplex or duplex will depend on the setup/installation conditions.

The SMA-M connector (22) of the optical fiber system (2) allowing coupling the optical fiber cable in an aligned and accurate way, in one side with the light source system (6) which transmit the light and, in the other side, with the CMOS micro-camera system (5) which is acting as a receptor sensor of the light that crosses the optical fiber. A SMA-M connector is coupled with the SMA-F connector (3) of the CMOS micro-camera system (5) and the other one is coupled with the SMA-F connector (4) of the light source system (6). This coupling mechanism of the SMA connectors allows an easy connection and disconnection of the optical fiber cable/wire when it is required.

The second system is the light source (6). Said system is composed mainly by a light source, an activation control stage, and a stabilization stage of the light source voltage. Each stage plays an important role on the system operation, the general features that is accomplished by each stage is explained as it follows. The main function of the voltage stabilizer stage is to guarantee that the electric supply has the quality and characteristics of voltage required. The coherent light source stage corresponds finally to the light emitting source. The activation control stage of the electronics is the one that analyses that the system requirements needed, such as electric supply stability and activation configuration parameters, are being accomplished. Only after evaluating these conditions, the activation control stage will be able to send a valid activation signal to the coherent light source stage to start the operation.

In a preferred embodiment, the light source system (6) has a laser diode to emit coherent light. This diode emits a laser light with visible radiation in the 650 nm-660 nm wavelength interval. Due to its narrow bandwidth, allows focusing greater part of its energy within a specific area in comparison with a LED diode.

The high coherence that is presented by this laser light source helps the generation and identification of the speckled pattern in a more effective way by the CMOS system (5) A low-coherence light source could generate a speckled pattern too diffuse, leading to a hard detection of the speckled pattern. The light source system (6) is complemented with a stage in charge of stabilizing the voltage signal and an activation control stage that evaluates the necessary conditions to launch the operation of light emitting source.

The CMOS micro-camera system is the third system (5). The CMOS micro-camera system has a sensor of active pixels built with Complementary metal-oxide semiconductor (CMOS). The speckled pattern generated when illuminated by means of the light source traveling through the optical fiber, is detected with this sensor. The pattern is detected through the photosensitive array that the CMOS camera contains (51). The cells of the CMOS array are completely independent from their neighbors and the digitization is done pixel by pixel within the same sensor. Therefore, the displacement coordinates of each interference speckled pattern, generated when the optical fiber cable (21) is disturbed, can be obtained by means of the CMOS micro-camera.

In a preferred embodiment, the CMOS micro-camera has an operation voltage between 1.8 VDC and 5 VDC. In addition, the sensor has an operation frequency of 20 MHz and it works with temperatures between −10° C. and 60° C. The CMOS sensor has a dimension of 2 mm×2 mm.

The processing system is the fourth system (7). The processing system (7) uses a micro-controller where the resultant displacement of the speckle mots in a certain time over the CMOS array (51) is calculated. The information about the magnitudes of the specks displacement allows determining how strong the disturbance over the optical fiber cable was (21). Besides, in the processing system (7) the necessary thresholds are defined to be able to make a discrimination of the displacement levels that represent a real event and the ones which represent a false event, to further send the notification signals to the communications system (1).

Finally, the communications system is the fifth system (1). Said system includes a wired communication subsystem (10) that has a USB output and a dry contact output. In addition, in one embodiment of the invention, the communications system (1) also comprehends a WiFi communication subsystem (8), and a communication subsystem with multiple frequencies, such as 800 MHz-900 MHz (9), for instance.

In a preferred aspect, the USB communication (Universal Serial Bus) of the wired communication subsystem (10) follows a standard that defines cables, connectors, and protocols, used in a bus to connect, communicate and feed electrical supply between computers, peripherals, and electronic devices. The USB connector allows communicating with a computer to execute the configurations for the device operation, Said USB output has compatibility with USB 2.0, it has transmission Low Speed of 1.5 MB/s and a transmission Full Speed of 12 MB/s.

In another preferred aspect, the dry contact output of the wired communication system (10), work with an electromagnetic device that, when stimulated with a very weak electrical current, opens or closes a circuit in which a greater power than the one in the stimulating circuit, is then dissipated. For the dry contact output, a relay with an activation voltage between 3.3 VDC and 30 VDC is used. The relay connection voltage goes until 125 VAC and its operation current can reach 1 A. It is important to considerate that according to the application type required, this relay can be changed for custom applications that may have a greater operation current range or a greater operation voltage range, regarding the available models.

The main function of the dry contact output is allowing the connection of external elements for the alarms notification or, for the activation of any external device of greater power. Some of the possible external elements for connection are sound beacons or audible, conventional alarms panels, communication modems, ON/OFF-type inputs for capturing images through CCTV (Closed-circuit television) systems, among others.

In a preferred embodiment, the WiFi communication subsystem (8) has the task to establish both short-distance and long-distance communication via WiFi with a router or a mobile device for the system parameter configuration and to send the live report of alarms and events. The WiFi communication module operates with the IEEE 802.11 b/g/n standard/protocol. Besides, security WPA/WPA2 is supported, and it has an operation frequency of 2.4 GHz. The device can communicate (or allows communication) via Internet with remote systems, by making part of IoT Network, or with administration systems with protocols API-REST and chat bots which allow the interaction with the system through CHAT applications, direct connections to ERPs and CRMs, which perform an integral management of perimeters.

In another preferred embodiment, the 800 MHz-900 MHz communication subsystem (9) provides long-distance wireless communication for the system parameters configuration, alarms/events live report, and this is information is sent to remote central module which has the capacity to interpreting which exact module or system is sending the information. The used module is distinguished for 1) having a line-view communication range from 1 to 21 Km, 2) allowing firmware updates through the air, by means of other compatible modems, and 3) having a RF data performance that can reach the 200 KB/s.

In another aspect of this invention, the communication system (1) includes the integration of other subsystems, the integration of both wired and wireless communication technologies such as the Modem GSM/3G/4G, Sigfox modules or NBC communication systems (Narrow Band Communication).

The device of the present disclosure, also has a mechanical housing (11) which contains all the device components except from the optical fiber system (2) and it is made of aluminum. The mechanical housing is composed by a CMOS camera holder base (12), a laser coupling base and CMOS camera (13), a SMA-F connector (3) of the CMOS micro-camera system (5), and a SMA-F connector (4) of the light source system (6).

In a preferred embodiment, the CMOS camera holder base (12) mechanically holds the CMOS camera and has a rectangular slot in the center, where the CMOS camera is placed. This base is built in ABS or aluminum.

In another preferred embodiment, the laser coupling base and the CMOS camera (13) mechanically supports the CMOS camera holder base (12) and the laser diode. In addition, in its external face, it has the SMA-F connectors (3) (4) through which the optical fiber system will be coupled (2). This base is built in ABS or aluminum.

The method for detecting vibrations in the periphery of an optical fiber comprises multiple steps; first, disturbances are produced in the optical fiber sensor cable (21), then, the respective speckled pattern of disturbances is read by the CMOS micro-camera system (5), these disturbances are projected over the CMOS array (51), that sends signals indicating the coordinates within the CMOS array (51) in which the disturbance is reflected.

Therefore, in the method is important to consider that, when the system first starts, the variables reading the changes of the coordinates projected over the CMOS array (51), which are controlled by the processing system (7), they are set in the value=(0,0). When receiving the coordinates signals by the CMOS array (51), the processing system (7) calculates the displacement generated by the disturbance taking the coordinate value (0,0) as the reference point, where said displacement is represented by a coordinate inside the CMOS array (51).

The processing system (7) performs the summation of all the speckle displacement magnitudes, the final displacement (df) can be calculated from said summation, using the equations of the FIG. 15. The resulting final displacement depends on all the displacements of the specks, calculated in a certain time period defined tl and to. This finals displacement acts as a reference to analyze the disturbance magnitude, allowing to recognize how strong the external disturbance applied was.

Further, once the time to take the displacement is finished, the displacement system (7) start decreasing the variables containing the value of the speckle coordinates (14), which were obtained by the CMOS micro-camera system (5). This decrement continues until the variable that obtains the vector magnitude data reaching a point of coordinates (x, y), returns to its initial position (0,0). The speed for generating these decrements is directly related to the system sensibility.

Then, the processing system (7) compares the final displacement information obtained, with different thresholds, in a way a discrimination or discernment can be done, to determine which speckle displacement levels (14) could discern a real event or a false one.

Additionally, the system uses a monitoring technique of the image quality obtained by the CMOS array (51). Said quality is measured by calculating the average of the information of each pixel, sent by the CMOS array (51). This image information depends on how the light source system (6), when traversing the optical fiber (2), affects each pixel in the CMOS array (51), allowing to diagnose the implementation status regarding its initial status configuration.

Finally, once the processing system (7) had performed the analysis, it is able to send each event notification using the communication system (1), whether using an output medium through the wired communication subsystem (10), or via wireless through the WiFi communication subsystem (8), or the 800 MHz-900 MHz communication subsystem (9), or any transmission method.

In a preferred embodiment, the device announced has the advantage of allowing the user to configure three parameters of easy operation, adjustable with a software tool for each zone and installation type. Such parameters are: sensibility, analysis time and activation duration. The variation on the analysis time, allows having a sensibility adjust in the reference measure. Such analysis period can be adjusted in a range between 1 ms-40 ms.

The device for detecting vibrations in the periphery of an optical fiber has different purposes beyond the perimeter security; in an embodiment, the device can be used over the motor bases to determine when they are ON, or analyzing its vibration modes, with which its operation status or failures diagnose is determined. In another embodiment, it can be used with a blanket for critical patients to analyze the vital signs, or to alert for the patient excessive still time, also, in transport systems for detection and counting of vehicle axles, among others.

In one use the device can be used to delimit restricted areas by embedding it in the floor, determining when the person or the object crosses a specific line. In other use, the system can be used to create smart mats, which could announce when somebody steps on them. Finally, the device can also be used to determine when a mountain landslide would occur, a structure collapses or to detect earthquakes.

### BRIEF DESCRIPTION OF THE DRAWINGS

Aiming to facilitate the understanding of this invention, a detailed description of the here presented drawings will be made:

FIG. 1 is a block diagram, which represents the main systems of the invention.

FIG. 2 is a representation of the top view with mechanical housing transparency of the device.

FIG. 3 is a representation of the top view without mechanical housing.

FIG. 4 represents the bottom view of the top view without mechanical housing of the device.

FIG. 5 is a representation of the external view of the mechanical housing from different angles.

FIG. 6 is a representation from the way in which the optical fiber system connects to the mechanical housing.

FIG. 7 represents the way in which the fiber optical sensor wire connects to the mechanical junction.

FIG. 8 represents the installations with different types of optical fibers. FIG. 8a represents the production of the invention in which simplex optical fiber was used. FIG. 8b represents the production of the invention in which duplex optical fiber was used.

FIG. 9 represents the detail of the coupling mechanics of the two SMA connectors.

FIG. 10 represents the visual detail of the lateral side from the mechanical housing with the USB connector and the dry contact connectors.

FIG. 11 represents the three-dimensional detail of the base of the CMOS camera holder.

FIG. 12 represents the three-dimensional detail of the base of the laser coupling and of the CMOS camera.

FIG. 13 represents the detail of the CMOS camera micro system.

FIG. 14 represents the CMOS array with the specks, when disturbed.

FIG. 15 corresponds to the formula required to calculate the final displacement.

FIG. 16 represents the processing which is made after the disturbance of the optical fiber.

FIG. 17 is a block diagram with the main stages of the light source system.

### DETAILED DESCRIPTION OF A PREFERRED EMBODIMENT

The following detailed description of the invention refers to the here attached figures. Although the description already includes feasible examples, others are also possible and changes of the performance can also be made. Changes to the invention are possible and should be considered by those who are well versed. However, many changes could lead to results that go beyond the scope of the invention.

FIG. 1 shows a block diagram which represents the main systems of the invention. The light source system (6) generates light, which is transmitted through an optical fiber system (2). This system detects the disturbances from the exterior and shows them through light pattern changes.

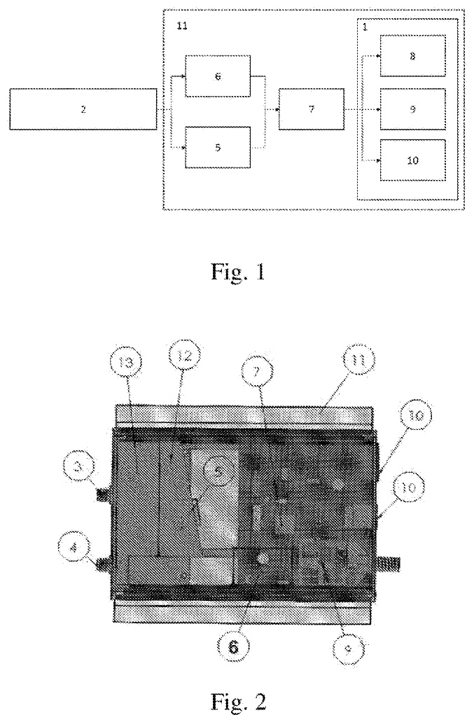

FIG. 2 is a representation of the top view with transparency of the mechanical housing (11). In the figure the coupled parts of the mechanical housing are illustrated (11). The mechanical housing consists of one CMOS camera holder base (12), one laser coupling base and CMOS camera (13), one SMA-F connector (3) of the CMOS micro-camera system (5) and the SMA-F connector (4) of the light source system (6).

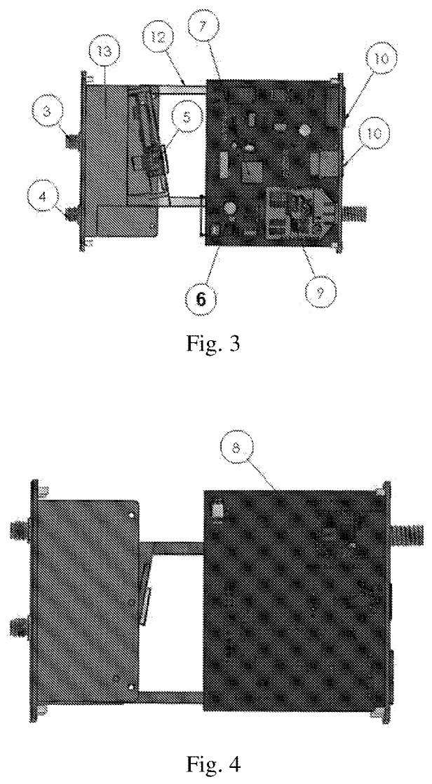

FIG. 3 represents the top view without the mechanical housing of the device (11). In this figure it is illustrated how the systems, which are located inside the mechanical housing (11), are distributed. It is evidenced that the light source system (6) is located in the same side as its respective SMA-F connector (4). In this way, the mechanical coupling and the wiring connection are facilitated. Furthermore, it is shown that the CMOS micro-camera system (5) is located near to the SMA-F connector (3) of the CMOS micro-camera system (5). Thus, the connection between the both elements is favored. Additionally, the process system (7) is located in the center of the mechanical housing because it must have connections with the rest of the systems located inside the mechanical housing (11). Moreover, it is illustrated that the wire communication subsystem (10) corresponds to one USB output and one dry contact output. These subsystems are located at one end of the device in order to favor the communication with the exterior.

FIG. 4 represents the inferior view without the mechanical housing of the device. Here is shown that the WiFi communication subsystem (8), which is connected to the inferior view of the electronic card to optimize the space.

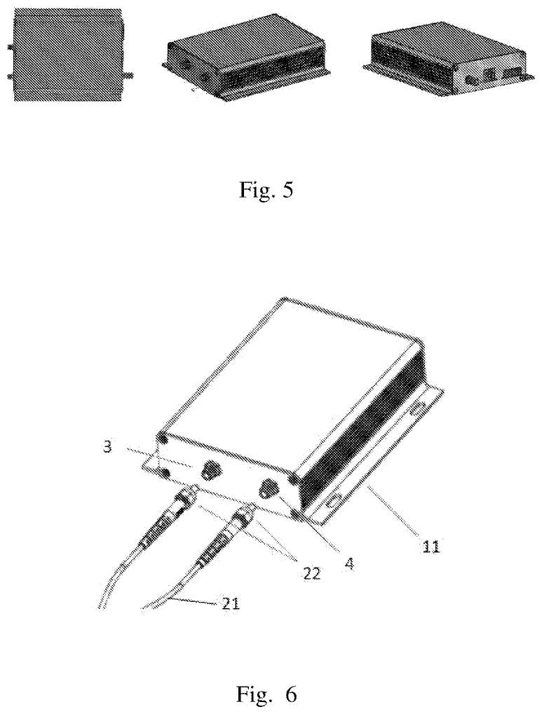

FIG. 5 represents the exterior view of the mechanical housing (11) from different angles. Here is depicted that the housing is made of aluminum and it has a rectangular shape with approximate dimensions of 12 cm long, 3 cm high and 10 cm wide.

In FIG. 6 the way in which the optical fiber system (2) is connected to the mechanical housing (11) is shown. In the figure are depicted the SMA-M connectors (22), which are connected to the ends of the optical fiber sensor wire (21). The SMA-F connector of the CMOS micro-camera system (3) and the light source system (4) are also shown.

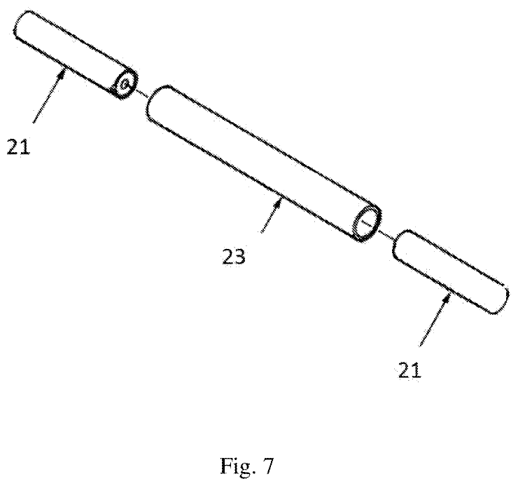

FIG. 7 represents the way in which the mechanical coupling (23) is connected to the ends of the duplex optical fiber sensor wire (21). This coupling (23) allows a permanent binding between the ends of the optical fiber. Moreover, the coupling (23) has a good optical performance, determined by a low attenuation, a minimal reflectance and a high mechanical resistance.

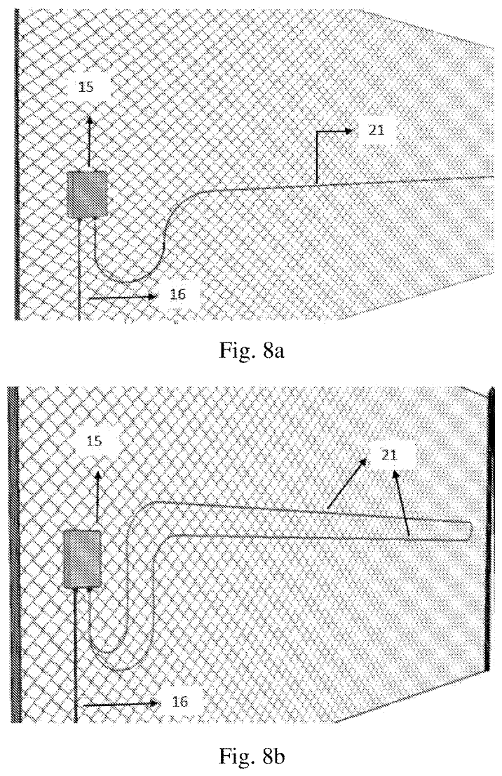

FIG. 8a shows the simplex optical fiber wire (21). Here it is shown the single filament which covers the mesh to protect it. Furthermore, the figure illustrates one watertight box (15), which is used for the outside and in which the mechanical housing (11) is located

In FIG. 8b a duplex optical fiber wire (21) is used the installation. The two filaments of the fiber are shown, which covers the mesh to protect it. Moreover, the figure shows a multi-pair cable (16) which allows the device supply while connecting the dry contact outputs (10), which has the device to notify the alarm.

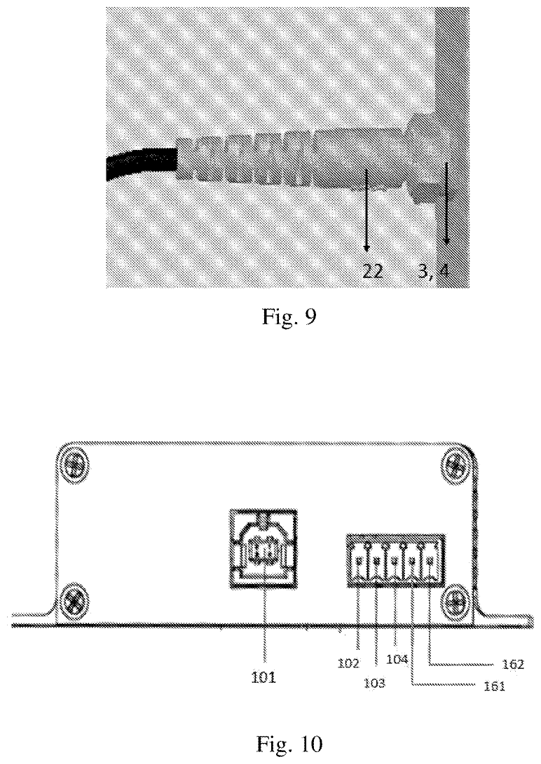

FIG. 9 presents the SMA-M connector (22) coupling mechanics in detail. This is coupled to the optical fiber wire (21) and its end is threaded with the SMA-F (3)(4) connector, which is secured to the mechanical housing (11) and has the shape of a threaded screw.

In an embodiment form presented in the FIG. 10, the detail of the lateral view of the mechanical housing (11) is shown, where the outputs of the wired communication subsystem (10) can be observed. On the one hand, the USB connector output (101) is shown. This is a communication port used to configure the system, and alternatively, to allow feeding the device with energy supply. In addition, it shows dry contact relay out terminals, which include: a normally-open terminal—NA (102), a common terminal—COM (103), and a normally-closed terminal—NC (104). Finally, the FIG. 10 shows the terminals to feed the device, corresponding to the ground terminal—GND (161), and the voltage terminal—VCC (162).

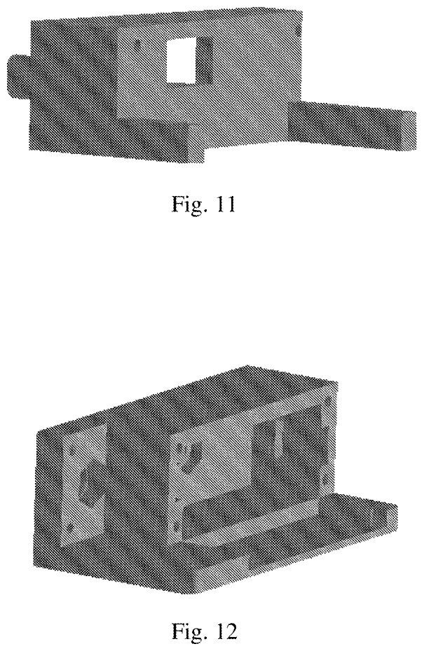

In a preferred embodiment of the invention, shown in the FIG. 11, the three-dimensional detail of the CMOS camera holder base (12), which mechanically holds the CMOS camera, is presented. Besides, it has a rectangular slot in the center, where the CMOS camera is coupled, and at its ends it has two rectangular couplings, allowing the connection with the electronic card. This base is built in ABS or aluminum.

In an embodiment shown in the FIG. 12, the three-dimensional detail of the laser and CMOS camera coupling base (13), which mechanically holds the CMOS camera holder base (12) and the laser diode, is presented. Additionally, in its internal face it has in the center two orifices allowing the connection of the CMOS micro-camera system (5) and the light source system (6) with the SMA-F connectors. In its external face, the SMA-F (3) (4) through which the optical fiber system will be coupled (2) are installed. This base is built in ABS or aluminum.

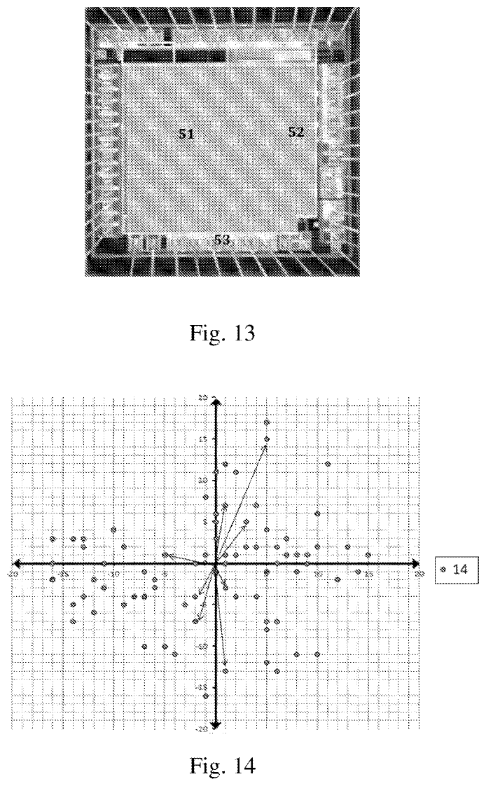

The FIG. 13 represents the detail of the CMOS micro-camera system (5), consisting of an active pixels sensor built with Complementary metal-oxide semiconductor (CMOS). Said sensor detects the light traversing the CMOS array (51) in the same sensor. Additionally, the CMOS sensor has a column decoder (53) and a row decoder (52) to translate the information, and also has a digital signal processor that digitizes the information of the light recorded by the CMOS array (51).

The FIG. 14 shows the CMOS array (51) photosensitive with the specks (14) when it is disturbed. The grid presented in the Cartesian plane corresponds to the CMOS array (51), where each cell represents a photosensitive pixel. Each speckle (14) presented in the CMOS array (51) belongs to an external disturbance applied to the optical fiber in a certain time. The arrows towards some specks represent the displacement magnitudes that each speckle has regarding the starting point (0,0). The summation of said displacements provides the require information to estimate how strong the disturbance applied to the optical fiber was.

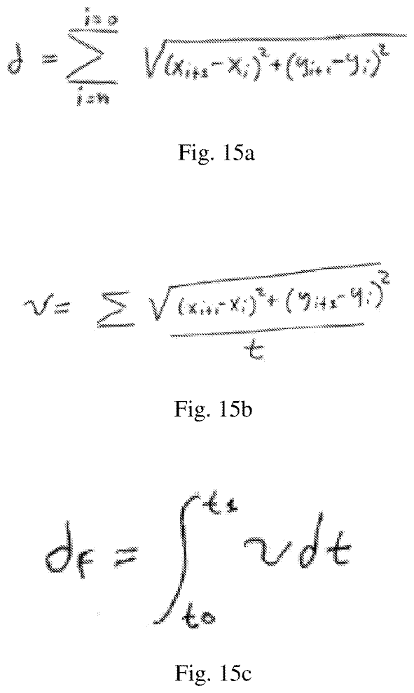

The FIG. 15 correspond to the formulas to calculate the final displacement variable in the processing system (7). The FIG. 15a corresponds to the formula to calculate the summation of the magnitudes of all the specks displacements (14). Then, the FIG. 15b corresponds to the formula to calculate the summation of the magnitudes of all the speeds resulting from dividing the displacements summation by the sampling time. Finally, the FIG. 15c corresponds to the formula to calculate the final displacement (df) with an integral of the summation of the speeds of all the specks. The final displacement is the accumulated value that serves as a reference to analyze the disturbance magnitude, allowing to estimate how strong the external disturbance applied was.

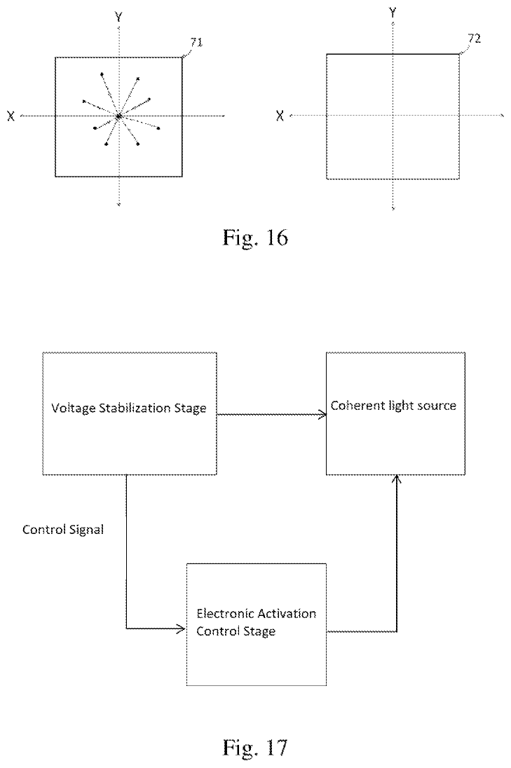

The FIG. 16 represents the processing done further to the disturbance of the optical fiber. Once the time to take the sample of the displacement is finished, the logic of the decrement (71) starts in the processing system (7), where the values of the variables containing the information of the speckle coordinates (14) are decreased. This decrement continues until the variable that obtains the vector magnitude data reaching a point of coordinates (x, y), returns to its initial position (0,0), which corresponds to the logic of reference point 0 (72).

The FIG. 17 is a block diagram that shows the main stages of the light source system. The voltage stabilizing stage guarantees that the electrical supply has the required voltage quality and features. The coherent light source stage corresponds finally to the light emitting source. The electronics activation control stage analyze if the system requirements (e.g. electrical supply stability and activation configuration parameters) are being met. Only after evaluating these conditions, the activation control stage will be able to send a valid activation signal to the coherent light source stage to start the operation.

1. A system that allows the detection of vibrations on the periphery of an optical fiber characterized by being light, economical, fast and with low energy consumption, which comprises:
a. a fiber optic system (2) that detects external disturbances and comprises an optical fiber sensor cable (21) and connectors (22) which are connected to both the light source system (6) and the CMOS micro-camera system (5);
b. a light source system (6) including a voltage stabilizing stage, a light source and an activation control stage; wherein said system generates a light that is transmitted through the fiber optic system (2) to which it is connected;
c. a CMOS micro-camera system (5 comprising a CMOS sensor that detects the light received from the fiber optic system (2) and a digital signal processing block which conditions the information of each pixel, represents them digitally and sends said signals with the coordinates of the speckled interference patterns within the CMOS array (51) to the processing system (7), said processing block is fast allowing the post processing in (7) to be much less;
d. a processing system (7) implemented in a lightweight micro-controller, in which the processing is done through the analysis of a speckled type interferometer pattern to determine the intensity of the disturbance generated in the fiber optic sensor cable (21), said fast and low-consumption processing includes: receiving the coordinates of the speckled interference patterns from the CMOS micro-camera system (5), calculating the displacement variables of each of the speckles, performing the summation of the magnitudes of the displacements of all the speckles (14), calculate the final displacement (df) in a sampling period by making an integral of the sum of the velocities of all the speckles (FIG. 15c), compare the final displacement with different thresholds, so that can determine a real event or a false event, and send alarm signals to the communication system (1);
e. a communication system (1) consisting of a wired communication subsystem (10) and a wireless communication subsystem, which connect the processing system (7) with the outside by sending alarm signals to it and receiving configuration parameters for the processing system (7).

2. The system of claim 1, wherein said fiber optic sensor cable (21) is a double-stranded duplex type and the two ends of the optic fiber (21) are joined by a mechanical joint (23).

3. The system of claim 1, wherein said because the fiber optic sensor cable (21) is simplex type, composed of a filament, wherein said fiber turns around on itself connecting at one end to the connector of the light source system (6) and at the other end to the CMOS micro-camera system (5).

4. The system of claim 1, wherein said connectors (22) of the fiber optic system (2) are of the SMA-M type.

5. The system of claim 1, wherein said light source system (6) comprises a laser light emitting diode.

6. The system of claim 1, wherein said wireless communication subsystem comprises a WiFi communication subsystem (8) and an 800 MHz-900 MHz communication subsystem.

7. The system of claim 1, wherein said wired communication subsystem (10) includes a USB output and a dry contact output.

8. The system of claim 1, wherein the light source system (6), the CMOS micro-camera system (5), the processing system (7) and the communication system (1) are placed in a mechanical housing (11) which is coupled through SMA-F connectors (3) (4) to the fiber optic system (2).

9. The system of claim 8, wherein said mechanical housing (11) is composed of a CMOS camera holder base (12), a CMOS camera and laser coupling base (13), an SMA-F connector of the CMOS micro-camera system (3) and an SMA-F connector from the light source system (4).

10. A method for detecting of vibrations in the periphery of an optical fiber and is implemented in a low-cost and light micro-controller, said method comprises the stages of:
a. Reading the speckled pattern of disturbances through the CMOS micro-camera system (5) that makes the projection of the speckles (14) over the CMOS array (51);
b. Sending signals to the processing system (7) from the CMOS micro-camera system (5),where said signals indicate the coordinates of the disturbance speckles within the CMOS array (51);
c. Calculating in the processing system (7) the displacement variables of each of the speckles by variables (x, y), when the system starts for the first time, these variables are automatically established with their initial value, this value is the position of all the speckles detected at a zero instant, at position (0,0) which will be the reference point in the calculation;
d. Performing the summation of the displacement magnitudes of all the speckles (14);
e. Calculating the final displacement (df) in a sampling period by performing an integral of the summation of the velocities of all the speckles. The final displacement obtained depends on all the displacement of the speckles (14) calculated in a determined period of time and allows to know how strong the external disturbance was applied;
f. Starting the decrement logic (71) of the variables that contain the value of the coordinates of the speckles (14). This decrement begins in the opposite direction to the increment when the time to take the displacement sample finishes, and it is done until the variable responsible for obtaining the data of the magnitude of the vector with coordinates (x, y) returns to its initial position (0,0);
g. Comparing the information obtained on the final displacement with different specified thresholds so that it can be determined which displacement levels of the speckles (14) generate a real event or a false event; it is determined if it is a real event or a false alarm by comparing with the reference data;
i. Sending signals representing the type of event detected from the processing system (7) to the communication system (1).

11. The method of claim 10, further comprising: a technique for monitoring the quality of the image obtained by the CMOS array (51) and processed by the processing system (7), which consists of determining the level of optical intensity received by the light source (6) averaging the optical intensity of all the pixels of the CMOS array (51), where this information allows diagnosing the correct alignment of the optical coupling, and inferring about the state and correct operation of the optical fiber (21) and the light source (6).
